(19) United States
(12) Patent Application Publication
(10) Pub. No.: US 2023/0216642 A1
(43) Pub. Date: Jul. 6, 2023

(54) JOINT BEAM MANAGEMENT SYNCHRONIZATION AND L1 MEASUREMENT PROCEDURE FOR NEW RADIO SYSTEMS

(71) Applicant: MediaTek Singapore Pte. Ltd., Singapore (SG)

(72) Inventors: Bohan Zhang, San Jose, CA (US); Chunhua Geng, San Jose, CA (US); Chong-You Lee, Hsin-Chu (TW); Da-chun Hsing, Hsin-Chu (TW); Yanyan Qi, Beijing (CN); Wei-Jen Chen, Hsin-Chu (TW); Yabo Li, San Jose, CA (US)

(21) Appl. No.: 18/093,150

(22) Filed: Jan. 4, 2023

Related U.S. Application Data
(60) Provisional application No. 63/296,893, filed on Jan. 6, 2022.

(30) Foreign Application Priority Data
Dec. 31, 2022 (CN) 202211706187.8

(51) Int. Cl. H04L 5/00; H04W 24/02; H04W 24/08; H04W 48/08

(52) U.S. Cl. CPC H04L 5/0051; H04W 24/02; H04W 24/08; H04W 48/08

(57) ABSTRACT

A method to jointly perform beam management, synchronization, and L1 measurements using a single synchronization signal block (SSB) burst in NR systems is proposed to improve data rate and to reduce power consumption. In a scheduling based SSB method, a UE is scheduled to perform either beam management or synchronization and L1 measurements alternatively. In a joint SSB method, a UE performs beam management, synchronization, and L1 RSRP/SNR measurements within a single SSB burst simultaneously. The UE can dynamically switch between the two SSB methods based on predefined conditions. Further, multiple joint SSB modes are introduced for the joint SSB method, where either 3 OFDM symbols or 4 OFDM symbols of each SSB burst are used. UE can dynamically switch among the joint SSB modes depending on contamination level on the OFDM symbol carrying PSS.

### CROSS REFERENCE TO RELATED APPLICATIONS

This application claims priority under 35 U.S.C. § 119 from U.S. Provisional Application No. 63/296,893, entitled “Joint Beam Management, Synchronization, L1 Measurement Procedure for New Radio Systems”, filed on Jan. 6, 2022, the subject matter of which is incorporated herein by reference.

### TECHNICAL FIELD

The disclosed embodiments relate generally to wireless communication, and, more particularly, to a method for joint beam management, synchronization, and L1 measurement procedure in 5G New Radio (NR) cellular communication networks.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The next generation mobile network (NGMN) board has decided to focus the future NGMN activities on defining the end-to-end requirements for 5G new radio (NR) systems. In 5G NR, the base stations are also referred to as gNodeBs or gNBs.

Frequency bands for 5G NR are being separated into two different frequency ranges. Frequency Range 1 (FR1) includes sub-6 GHz frequency bands, some of which are bands traditionally used by previous standards, but has been extended to cover potential new spectrum offerings from 410 MHz to 7125 MHZ. Frequency Range 2 (FR2) includes frequency bands from 24.25 GHz to 71.0 GHz. Bands in FR2 in this millimeter wave (mmWave) range have shorter propagation range but higher available bandwidth than bands in FR1. To compensate for high propagation loss in 5G mmWave systems, a UE is usually equipped with multiple antennas to enable beamforming. For downlink data reception, beam management (BM), synchronization (both time and frequency), and accurate layer 1 (L1) measurements of reference signals are required at a UE.

As in LTE, the primary synchronization signal (PSS) and the secondary synchronization signal (SSS) in 5G NR represent the physical cell identity (PCI), and the Physical broadcast channel (PBCH) carries the master information block (MIB). The SS Block (SSB) in 5G NR stands for Synchronization Signal Block and it refers to synchronization signal (PSS/SSS) and PBCH block because the synchronization signal and PBCH channel are packed as a single block. The SSB is transmitted periodically and each SSB burst comprises PSS/SSS and PBCH. In a conventional design, beam management, synchronization, and L1 RSRP/SNR measurements operate on different SSBs. A design to jointly perform beam management, synchronization, and L1 RSRP/SNR measurements will greatly benefit a UE in terms of data rate and power consumption.

### SUMMARY

A method to jointly perform beam management, synchronization, and L1 measurements using a single synchronization signal block (SSB) burst in NR systems is proposed to improve data rate and to reduce power consumption. In a scheduling based SSB method, a UE is scheduled to perform either beam management or synchronization and L1 measurements alternatively. In a joint SSB method, a UE performs beam management, synchronization, and L1 RSRP/SNR measurements within a single SSB burst simultaneously. The UE can dynamically switch between the two SSB methods based on predefined conditions. Further, multiple joint SSB modes are introduced for the joint SSB method, where either 3 OFDM symbols or 4 OFDM symbols of each SSB burst are used. UE can dynamically switch among the joint SSB modes depending on pilot contamination level on the OFDM symbol carrying PSS.

In one embodiment, a UE monitors synchronization signal block (SSB) transmission in a mobile communication network, wherein the SSB transmission comprises SSB bursts that are periodically transmitted from the network to the UE. The UE receives, within a single SSB burst, a primary synchronization signal (PSS), a secondary synchronization signal (SSS), and a physical broadcast channel (PBCH). The UE performs an operation using a joint SSB method for beam management, and at least one of a synchronization and an L1 measurement simultaneously using the received PSS, SSS, and PBCH within the single SSB burst. In one example, the UE determines predefined conditions for dynamically switching between the joint SSB method and a scheduling based SSB method. In another example, the UE determines a pilot contamination level for dynamically switching between different joint SSB modes under the joint SSB method.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G New Radio (NR) network having a UE that performs joint beam management, synchronization, and L1 measurements using the same synchronization signal block (SSB) burst in accordance with aspects of the current invention.

FIG. 2 illustrates simplified block diagrams of wireless devices, e.g., a UE and a gNB in accordance with embodiments of the current invention.

FIG. 3 illustrates periodic SSB transmission and joint beam management, synchronization, and L1 measurements using the same SSB burst.

FIG. 4 illustrates different examples of joint beam management, synchronization, and L1 measurements using the same SSB burst in accordance with embodiments of the current invention.

FIG. 5 illustrates a first embodiment of performing different scheduling based or joint-based SSB methods for beam management, synchronization, and L1 measurements using a predefined condition.

FIG. 6 illustrates a second embodiment of performing different joint SSB modes of joint beam management, synchronization, and L1 measurements using a predefined condition.

FIG. 7 is a flow chart of a method for joint beam management, synchronization, and L1 measurements in accordance with one novel aspect.

### DETAILED DESCRIPTION

Reference will now be made in detail to some embodiments of the invention, examples of which are illustrated in the accompanying drawings.

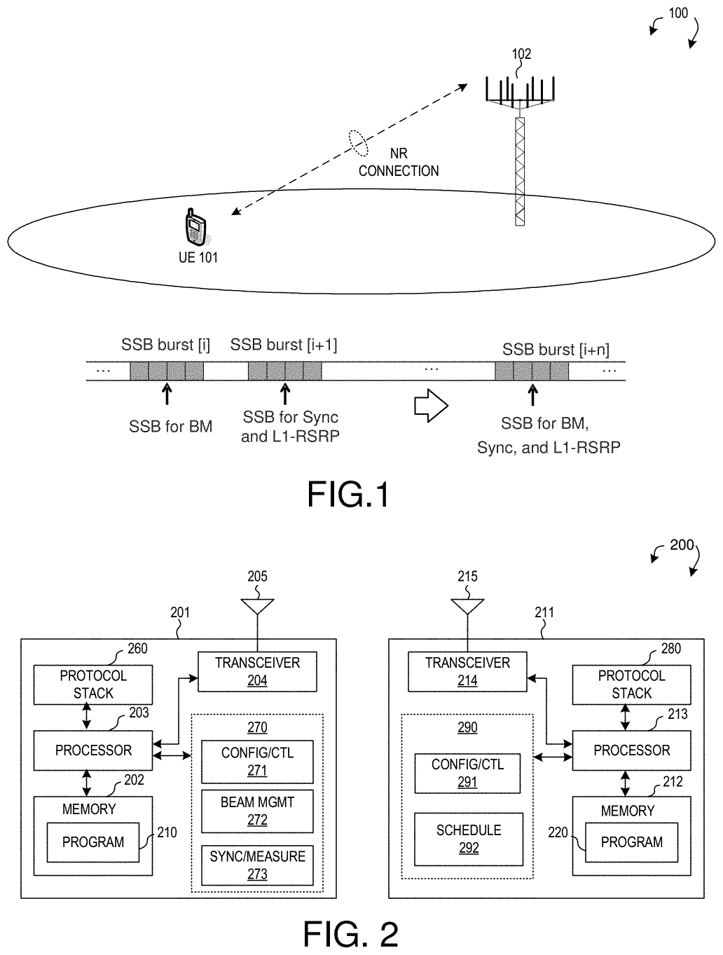

FIG. 1 illustrates an exemplary 5G New Radio (NR) network 100 having a UE that performs joint beam management, synchronization, and L1 measurements using the same synchronization signal block (SSB) burst in accordance with aspects of the current invention. The 5G NR network 100 comprises a User Equipment (UE) 101 and a plurality of base stations including a serving base station (gNB) 102. UE 101 is communicatively connected to the serving gNB 102, which provides radio access using a Radio Access Technology (RAT) (e.g., the 5G NR technology). The UE 101 may be a smart phone, a wearable device, an Internet of Things (IoT) device, and a tablet, etc. Alternatively, UE 101 may be a Notebook (NB), or Personal Computer (PC) inserted or installed with a data card which includes a modem and RF transceiver(s) to provide the functionality of wireless communication. To compensate for high propagation loss in 5G mmWave systems, a UE is usually equipped with multiple antennas to enable beamforming. For downlink (DL) data reception, beam management (BM), synchronization (time and frequency) and accurate L1 measurements of reference signals are required at a UE.

As in LTE, the primary synchronization signal (PSS) and the secondary synchronization signal (SSS) in 5G NR represent the physical cell identity (PCI), and the Physical broadcast channel (PBCH) carries the master information. block (MIB). The SS Block (SSB) in 5G NR stands for Synchronization Signal Block and it refers to synchronization signal (PSS/SSS) and PBCH block because the synchronization signal and PBCH channel are packed as a single block. The SSB is transmitted periodically and each SSB burst comprises PSS/SSS and PBCH. In a conventional design, beam management, synchronization, and RSRP/SNR measurements operate on different SSBs, which is referred as scheduling based SSB operation. A design to jointly perform beam management, synchronization, and RSRP/SNR measurements will greatly benefit a UE in terms of data rate and power consumption.

In accordance with one novel aspect, a method to jointly perform beam management, synchronization, and RSRP/SNR measurements simultaneously using a single SSB burst in NR systems is proposed to improve data rate and to reduce power consumption. This new method is also referred as a joint SSB operation. As depicted in FIG. 1, a single SSB burst [i] is conventionally used for BM, and the next single SSB burst [i+1] is conventionally used for synchronization and L1 measurements, alternatively. in one novel aspect, under joint SSB operation, a single SSB burst [i+n] is used for BM, synchronization, and L1-RSRP measurements simultaneously. The joint SSB operation can be performed under different joint SSB modes. Depending on different conditions, the UE can dynamically switch to different joint SSB modes for the joint SSB operation, or the UE can switch between joint SSB operation and scheduling based SSB operation dynamically, adjusting to traffic conditions.

FIG. 2 illustrates simplified block diagrams of wireless devices, e.g., a UE 201 and a gNB 211 in accordance with embodiments of the current invention in 5G NR network 200. The gNB 211 has an antenna 215, which transmits and receives radio signals. An RF transceiver module 214, coupled with the antenna 215, receives RF signals from the antenna 215, converts them to baseband signals and sends them to the processor 213. The RF transceiver 214 also converts received baseband signals from the processor 213, converts them to RF signals, and sends out to the antenna 215. The processor 213 processes the received baseband signals and invokes different functional modules to perform features in the gNB 211. The memory 212 stores program instructions and data 220 to control the operations of the gNB 211. In the example of FIG. 2, the gNB 211 also includes a protocol stack 280 and a set of control function modules and circuits 290. The protocol stack 280 may include a Non-Access-Stratum (NAS) layer to communicate with an AMF/SMF/MME entity connecting to the core network, a Radio Resource Control (RRC) layer for high layer configuration and control, a Packet Data Convergence Protocol/Radio Link Control (PDCP/RLC) layer, a Media Access Control (MAC) layer, and a Physical (PHY) layer. In one example, the control function modules and circuits 290 include a configuration circuit for configuring measurements report and active set for UE, and a handover handling circuit for sending cell-switch to the UE upon handover decision.

Similarly, the UE 201 has a memory 202, a processor 203, and an RF transceiver module 204. The RF transceiver 204 is coupled with the antenna 205, receives RF signals from the antenna 205, converts them to baseband signals, and sends them to the processor 203. The RF transceiver 204 also converts received baseband signals from the processor 203, converts them to RF signals, and sends out to the antenna 205. The processor 203 processes the received baseband signals (e.g., comprising an SCell/PSCell addition/activation command) and invokes different functional modules and circuits to perform features in the UE 201. The memory 202 stores data and program instructions 210 to be executed by the processor 203 to control the operations of the UE 201. Suitable processors include, by way of example, a special purpose processor, a Digital Signal Processor (DSP), a plurality of micro-processors, one or more micro-processor associated with a DSP core, a controller, a microcontroller, Application Specific Integrated Circuits (ASICs), File Programmable Gate Array (FPGA) circuits, and other type of Integrated Circuits (ICs), and/or state machines. A processor in associated with software may be used to implement and configure features of the UE 201.

The UE 201 also includes a protocol stack 260 and a set of control function modules and circuits 270. The protocol stack 260 may include a NAS layer to communicate with an AMF/SMF/MME entity connecting to the core network, an RRC layer for high layer configuration and control, a PDCP/RLC layer, a MAC layer, and a PHY layer. The Control function modules and circuits 270 may be implemented and configured by software, firmware, hardware, and/or combination thereof. The control function modules and circuits 270, when executed by the processor 203 via program instructions contained in the memory 202, interwork with each other to allow the UE 201 to perform embodiments and functional tasks and features in the network. In one example, the control function modules and circuits 270 include a configuration and control circuit 271 for obtaining measurements and configuration information and controlling corresponding operation, a beam management circuit 272 for performing DL and UL beam management, and a synchronization and measurement handling circuit 273 for performing synchronization and L1 RSPR/RSRQ/SNR measurement functionalities based on the configuration received from the network.

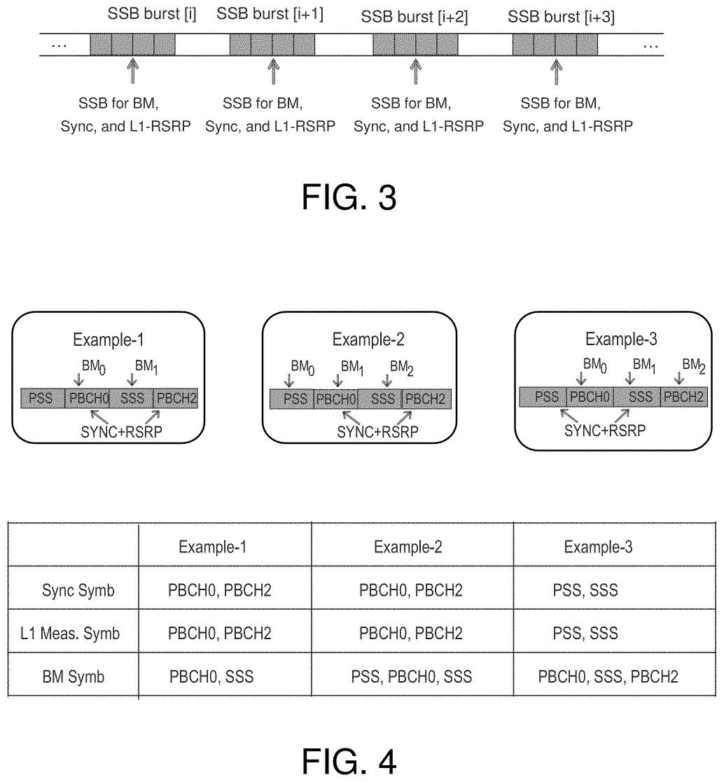

FIG. 3 illustrates periodic SSB transmission and joint beam management, synchronization, and L1 measurements using the same SSB burst. During cell search operations which are carried out when a UE is powered ON, mobility in connected mode, idle mode mobility (e.g., cell reselections or handover), inter-RAT mobility to NR system etc., the UE decodes NR synchronization signals and Physical Broadcast Channel (PBCH) to derive the necessary information required to access the cell. The Synchronization Signal/PBCH block (SSB) consists of PSS, SSS and PBCH. Synchronization signals can also be used by the UE for RSRP/RSRQ and SNR L1 measurements. In addition, beam management (BM) procedure is used in 5G NR in order to acquire and maintain a set of beams to ensure that gNB and UE beams are aligned for data communication. To enable beam-sweeping for PSS/SSS and PBCH, SS burst sets are defined. An SS burst set comprised of a set of SSBs, each SSB potentially be transmitted on a different beam. The network informs the UEs about which SSBs are being transmitted.

In the example of FIG. 3, an SSB burst is periodically transmitted with a periodicity (e.g., 5 ms, 10 ms, 20 ms, 40 ms, 80 ms, or 160 ms), depending on different numerology. A UE can assume a default periodicity of 20 ms during initial cell search or idle mode mobility. Conventionally, a single SSB burst [i] is either used. for BM or used for synchronization and L1 RSRP/RSRQ measurements, being scheduled alternatively. In one novel aspect, the OFDM symbols in a single SSB burst are used jointly for BM, synchronization, and L1 RSRP/RSRQ measurements. Within the same SSB burst [i], SSB burst [i+1], SSB burst [i+2], SSB burst [i+3], etc., BM, synchronization, and L1 RSRP/RSRQ measurements are performed simultaneously. Such UE operation is also referred as joint SSB method, while the conventional UE operation is referred as a scheduling based SSB method.

FIG. 4 illustrates different examples of joint beam management, synchronization, and L1 measurements using the same SSB burst in accordance with embodiments of the current invention. As depicted in FIG. 4, within each SSB burst, the synchronization signal PSS, SSS, and PBCH are always together in consecutive OFDM symbols. Each SSB burst occupies 4 OFDM symbols in the time domain and spread over 240 subcarriers (20 RBs) in the frequency domain. PSS occupies first OFDM symbol and span over 127 subcarriers. SSS is located in the third OFDM symbol and span over 127 subcarriers. There are 8 un-used subcarriers below SSS and 9 un-used subcarriers above SSS. PBCH occupies two full OFDM symbols (PBCH0 and PBCH2) spanning 240 subcarriers and in the third OFDM symbol spanning 48 subcarriers below and above SSS.

Three different working examples can be considered as different joint SSB modes for joint BM, synchronization, and L1 measurement operation. In a first Example-1, PBCH0 and PBCH2 symbols are used for synchronization and L1 measurement, PBCH0 and SSS symbols are used for beam management, and PSS is not used. In a second Example-2, PBCH0 and PBCH2 symbols are used for synchronization and L1 measurement, PSS, PBCH0 and SSS symbols are used for beam management. In a third Example-3, PSS and SSS symbols are used for synchronization and L1 measurements, PBCH0, SSS, and PBCH2 symbols are used for beam management. Depending on different UE configurations and real-time traffic conditions, UE can dynamically apply different joint SSB modes accordingly.

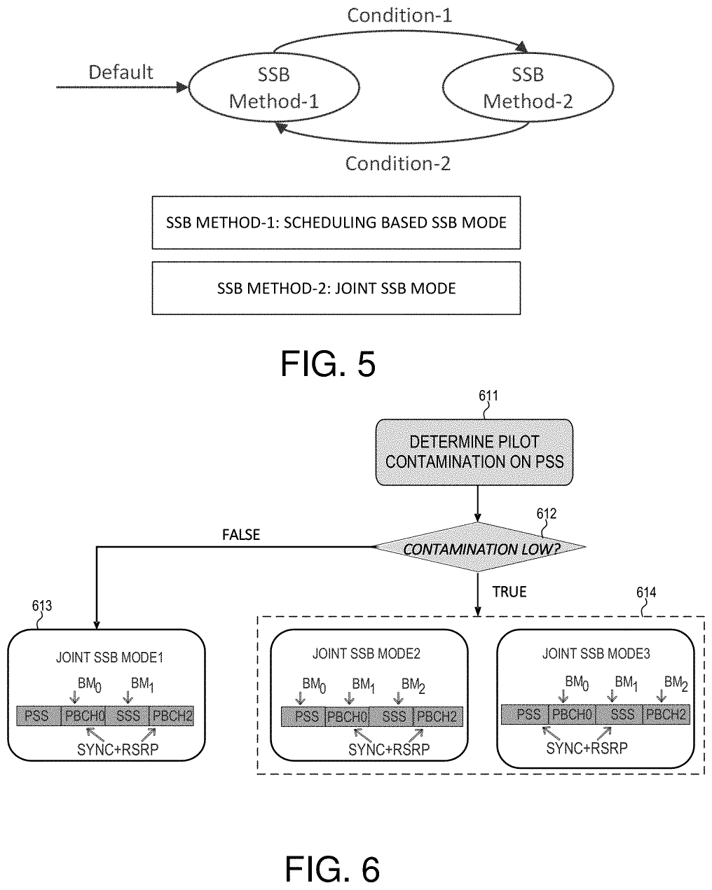

FIG. 5 illustrates a first embodiment of performing different SSB methods of scheduling based or joint beam management, synchronization, and L1 measurements using a predefined condition. In the embodiment of FIG. 5, two different SSB methods are used: SSB Method-1 is a scheduling based SSB method where the UE performs beam management, synchronization, and L1 measurements; SSB Method-2 is a joint SSB method where a single SSB burst is used jointly for BM, synchronization, and L1 RSRP/RSRQ measurements simultaneously.

In one novel aspect, a state machine is proposed to switch between the two methods of SSB Method-1 (scheduling based SSB method) and SSB Method-2 (joint SSB method). Two conditions are predefined for the switching between the two SSB Methods. Condition-1 is defined as: (DRX cycle<TH-1) && (SNR>TH-2) && (UE condition-1 depending on DL Data Traffic and BLER); Condition-2 is defined as (DRX cycle≥TH-3)∥(SNR≤TH-4)∥(UE condition-2 depending on DL Data Traffic and BLER). If Condition-1 is satisfied, then UE switches from SSB Method-1 to SSB Method-2; if Condition-2 is satisfied, then UE switches from SSB Method-2 to SSB Method-1. Note that in the state machine, SSB Method-1 may represent high performance mode, while SSB Method-2 may represent power saving mode. For SSB Method-2, it prefers not long DRX cycle, not low SNR, lower data rate required by UE, and no restriction on BLER (these requirements are basically Condition-1). For SSB Method-1, it can tolerant long DRX cycle, low SNR, offering high data rate and provide lower BLER (these benefits are basically Condition-2).

FIG. 6 illustrates a second embodiment of performing different joint SSB modes of joint beam management, synchronization, and L1 measurements using a predefined condition. In the embodiment of FIG. 6, three different joint SSB modes are defined under the joint SSB method. In joint SSB MODE1, PBCH0 and PBCH2 symbols are used for synchronization and L1 measurements, PBCH0 and SSS symbols are used for beam management, and PSS is not used. In joint SSB MODE2, PBCH0 and PBCH2 symbols are used for synchronization and L1 measurements, PSS, PBCH0 and SSS symbols are used for beam management. In joint SSB MODE3, PSS and SSS symbols are used for synchronization and L1 measurements, PBCH0, SSS, and PBCH2 symbols are used for beam management. Note that the joint SSB MODE1 only uses three OFDM symbols, and the PSS OFDM symbol is not used; while joint SSB MODE2 and joint SSB MODE3 use all four OFDM symbols.

In one novel aspect, in step 611, UE determines pilot contamination level on PSS and then decides which joint SSB mode to operate (step 612). If the pilot contamination level on PSS is higher than a threshold, then it is better not to use the PSS symbol. As a result, UE goes to step 613 and adopts joint SSB MODE1, e.g., PBCH0 and PBCH2 symbols are used for synchronization and L1 measurements, PBCH0 and SSS symbols are used for beam management, and PSS is not used. On the other hand, if the pilot contamination level on PSS is lower than a threshold, then UE goes to step 614 and adopts either joint SSB MODE2 or joint SSB MODE3, e.g., all four OFDM symbols are used for BM, synchronization and L1 measurements. In one example, the PSS contamination can be determined by comparing the Cell_ID_2 (the same Cell_ID_2 will generate the same PSS) between the serving cell and neighboring cells. If same Cell_ID_2 is found in the serving cell and one of the neighboring cells, then pilot contamination on PSS is detected.

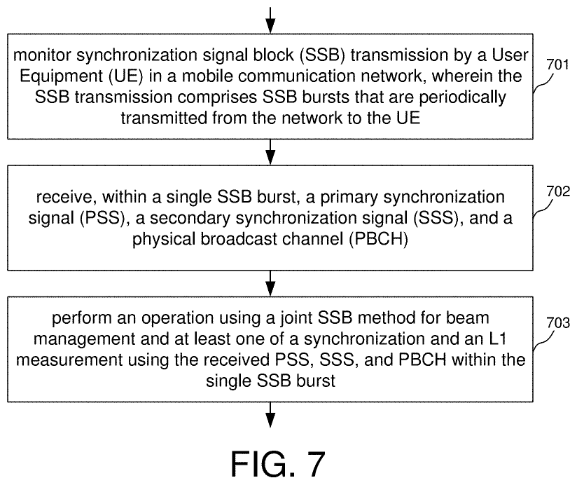

FIG. 7 is a flow chart of a method for joint beam management, synchronization, and L1 measurements in accordance with one novel aspect. In step 701, a UE monitors synchronization signal block (SSB) transmission in a mobile communication network, wherein the SSB transmission comprises SSB bursts that are periodically transmitted from the network to the UE. In step 702, the UE receives, within a single SSB burst, a primary synchronization signal (PSS), a secondary synchronization signal (SSS), and a physical broadcast channel (PBCH). In step 703, the UE performs an operation using a joint SSB method for beam management, and at least one of a synchronization and an L1 measurement using the received PSS, SSS, and PBCH within the single SSB burst. In one example, the UE determines predefined conditions for dynamically switching between the joint SSB method and a scheduling based SSB method. In another example, the UE determines a pilot contamination level for dynamically switching between different joint SSB modes under the joint SSB method.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
monitoring synchronization signal block (SSB) transmission by a User Equipment (UE) in a mobile communication network, wherein the SSB transmission comprises SSB bursts that are periodically transmitted from the network to the UE;
receiving, within a single SSB burst, a primary synchronization signal (PSS), a secondary synchronization signal (SSS), and a physical broadcast channel (PBCH); and
performing an operation using a joint SSB method for beam management, and at least one of a synchronization and an L1 measurements using the received PSS, SSS, and PBCH within the single SSB burst.

2. The method of claim 1, wherein the PSS, SSS, and PBCH are allocated in consecutive OFDM symbols within each SSB burst in time domain.

3. The method of claim 1, wherein the UE determines predefined conditions for dynamically switching between the joint SSB method and a scheduling based SSB method.

4. The method of claim 3, wherein the UE switches from the scheduling based SSB method to the joint SSB method when a first condition is satisfied.

5. The method of claim 3, wherein the UE switches from the joint SSB method to the scheduling based SSB method when a second condition is satisfied.

6. The method of claim 3, wherein the pre-defined conditions involve at least one of a discontinuous reception (DRX) cycle length, a Signal to noise ratio (SNR) value, downlink traffic, and a block error rate (BLER) value.

7. The method of claim 1, wherein the UE determines a pilot contamination level on PSS for the UE to dynamically switch between different joint SSB modes under the joint SSB method.

8. The method of claim 7, wherein the UE operates using a first joint SSB mode when the pilot contamination level on PSS is higher than a threshold.

9. The method of claim 7, wherein the UE operates using a second joint SSB mode when the pilot contamination level on PSS is lower than a threshold.

10. The method of claim 7, wherein the UE does not use the PSS under a first joint SSB mode, and wherein the UE uses the PSS under a second joint SSB mode.

11. A User Equipment (UE), comprising:
a transceiver that monitors synchronization signal block (SSB) transmission in a mobile communication network, wherein the SSB transmission comprises SSB bursts that are periodically transmitted from the network to the UE;
a decoder that decodes, within a single SSB burst, a primary synchronization signal (PSS), a secondary synchronization signal (SSS), and a physical broadcast channel (PBCH); and
a controller that performs an operation using a joint SSB method for beam management, and at least one of a synchronization and an L1 measurement using the received PSS, SSS, and PBCH within the single SSB burst.

12. The UE of claim 11, wherein the PSS, SSS, and PBCH are allocated in consecutive OFDM symbols within each SSB burst in time domain.

13. The UE of claim 11, wherein the UE determines predefined conditions for dynamically switching between the joint SSB method and a scheduling based SSB method.

14. The UE of claim 13, wherein the UE switches from the scheduling based SSB method to the joint SSB method when a first condition is satisfied.

15. The UE of claim 13, wherein the UE switches from the joint SSB method to the scheduling based SSB method when a second condition is satisfied.

16. The UE of claim 13, wherein the pre-defined conditions involve at least one of a discontinuous reception (DRX) cycle length, a Signal to noise ratio (SNR) value, downlink traffic, and a block error rate (BLER) value.

17. The UE of claim 11, wherein the UE determines a pilot contamination level on PSS for dynamically switching between different joint SSB modes under the joint SSB method.

18. The UE of claim 17, wherein the UE operates using a first joint SSB mode when the pilot contamination level on PSS is higher than a threshold.

19. The UE of claim 17, wherein the UE operates using a second joint SSB mode when the pilot contamination level on PSS is lower than a threshold.

20. The UE of claim 17, wherein the UE does not use the PSS under a first joint SSB mode, and wherein the UE uses the PSS under a second joint SSB mode.
